(19) United States
(12) Patent Application Publication
(10) Pub. No.: US 2009/0030762 A1
(43) Pub. Date: Jan. 29, 2009

(54) METHOD AND SYSTEM FOR CREATING A DYNAMIC AND AUTOMATED TESTING OF USER RESPONSE

(76) Inventors: Hans C. Lee, Carmel, CA (US); Timmie T. Hong, San Diego, CA (US); William H. Williams, Hilo, HI (US)

Correspondence Address: COURTNEY STANIFORD & GREGORY LLP, P.O. BOX 9686, SAN JOSE, CA, 95157, US

(21) Appl. No.: 12/180,510

(22) Filed: Jul. 25, 2008

Related U.S. Application Data
(60) Provisional application No. 60/962,486, filed on Jul. 26, 2007.

(51) Int. Cl. G06F 17/30

(52) U.S. Cl. 705/7

(57) ABSTRACT

The present invention enables large scale media testing by human testers, where each tester may see multiple pertinent media instances during a single testing session and choose the optimal overall pairings between the testers and the media instances to minimize the number of testers needed for each testing project. By increasing the number of pertinent media views produced by each tester during each testing session, the approach increases the efficiency of media testing and reduces testing costs and time.

### RELATED APPLICATIONS

This application claims priority to U.S. Provisional Patent Application No. 60,962,486, filed Jul. 26, 2007, and entitled “Method and system for creating a dynamic and automated clutter reel for testing of user response that greatly increases information gained,” by Hans C. Lee et al., and is hereby incorporated herein by reference.

### BACKGROUND

1. Field of Invention

This invention relates to the field of media rating based on physiological response from viewers.

2. Background of the Invention

In testing a viewer's response to a piece of media, a clutter reel (such as a playlist of media instances) is often created where multiple advertisements or other media instances may be shown in a row, with the media instance in question as one member of the clutter reel. The clutter reel is made specifically for testing of a specific media instance and is designed to answer a specific question about the media instance in question. However, the clutter reel may also induce bias if is static, because every viewer (tester of the media instances) will watch the media instances in the clutter reel in the same order. Consequently, testers often do not focus on any one piece of media, allowing their experiences with earlier media instances to influence/bias their viewing and subsequent feelings/responses to later ones. There is a need for a process, which would enable efficient testing of a large number of media instances by a large group of testers to obtain the most pertinent data from the testers during a testing session.

### SUMMARY OF INVENTION

The present invention enables large scale media testing by human testers, where each tester may see multiple pertinent media instances during a single testing session and choose the optimal overall pairings between the testers and the media instances to minimize the number of testers needed for each testing project. By increasing the number of pertinent media views produced by each tester during each testing session, the approach increases the efficiency of media testing and reduces testing costs and time.

### BRIEF DESCRIPTION OF THE DRAWINGS

FIG. 1 is an illustration of an exemplary system to support large scale media testing by human testers.

FIG. 2 is a flow chart illustrating an exemplary process to support large scale media testing by human testers.

FIG. 3 is a flow chart illustrating an exemplary process to support large scale media testing during a testing session.

FIG. 4 (a)-(c) show an exemplary integrated headset used with one embodiment of the present invention from different angles.

### DETAILED DESCRIPTION OF EMBODIMENTS OF THE INVENTION

The invention is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

An approach to large scale media testing by human testers is enabled, which allows each tester to see multiple pertinent media instances during a single testing session and chooses the optimal overall pairings between the testers and the media instances to minimize the number of testers needed for each testing project. By increasing the number of pertinent media views produced by each tester during each testing session, the approach increases the efficiency of media testing and reduces testing costs and time.

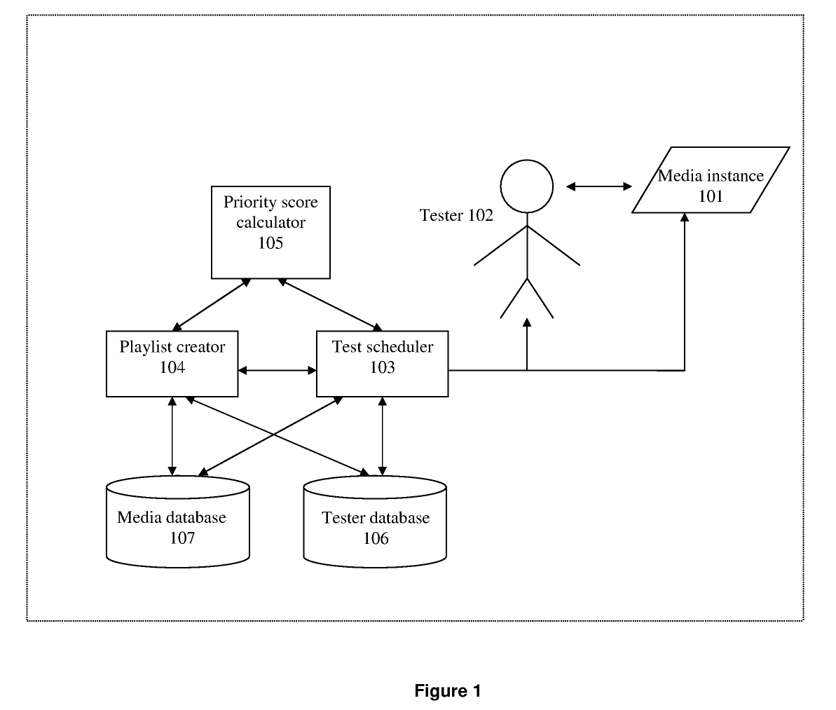

FIG. 1 is an illustration of an exemplary system to support large scale media testing by human testers. Although this diagram depicts components as functionally separate, such depiction is merely for illustrative purposes. It will be apparent to those skilled in the art that the components portrayed in this figure can be arbitrarily combined or divided into separate software, firmware and/or hardware components. Furthermore, it will also be apparent to those skilled in the art that such components, regardless of how they are combined or divided, can execute on the same computing device or multiple computing devices, and wherein the multiple computing devices can be connected by one or more networks.

Referring to FIG. 1, a test scheduler 103 is the control module that chooses and schedules a plurality of testers 102 for a set of media instances 101 to be tested for a testing project. The test scheduler 103 determines which testers would create the highest amount of pertinent test data, thereby maximizing the efficiency of the testing system. Here, a media instance can be but is not limited to, a video, a video game, a TV commercial, a printed media, a web site, etc. The pertinent data is defined as a set of metrics that is needed to make conclusions about a media instance and/or its priorities to be tested. A playlist creator 104 creates for each given tester a playlist of media instances that have the highest “priority score” for that tester. A priority score calculator 105 calculates a priority score of a specific media instance as being viewed by a specific tester. Additionally, the priority score calculator calculates the overall priority of the set of media instances on the playlist of the tester. A tester database 106 stored information (metadata) pertaining to each of the testers, which allows the testers to be divided into various categories. A media database 107 stores pertinent data for each instance of media and/or data recorded from viewing of the media instances by the testers.

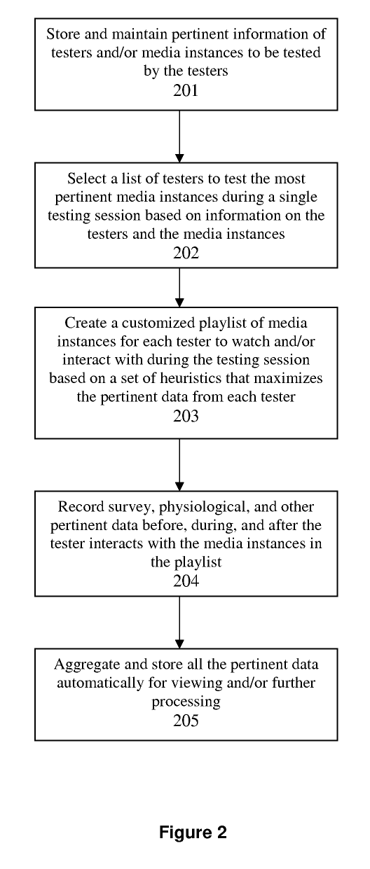

FIG. 2 is a flow chart illustrating an exemplary process to support large scale media testing by testers. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

Referring to FIG. 2, pertinent information of testers and/or media instances to be tested by the testers are stored and maintained at step 201. At step 202, a list of testers to test the most pertinent media instances during a single testing session is selected based on the information on the testers and the media instances. For each tester, a customized playlist of media instances to watch and/or interact with during the testing session is created to maximize the pertinent test data provided from each tester at step 203. At step 204, survey, physiological and other pertinent data before, during, and after the tester interacts with the media instances in the playlist during the testing session can be recorded. Finally at step 205, all the pertinent test data are aggregated and stored automatically for viewing and/or processing.

### Test Scheduler

In some embodiments, inputs to the test scheduler may include at least one or more of the following:
A database of testers, which allows the scheduler to access all possible testers and the pertinent information stored about them.
A playlist created by the playlist creator for each tester in the database, wherein the playlist is filled with the optimal set of media instances that are most pertinent for the tester to watch.
Priority of information (priority score) gained by a specific tester viewing a set of media instances on the playlist, which can be calculated by the priority score calculator based on at least one or more of: metrics of data about the tester, the media instances, the testing project and other pertinent sources. The result is a comparable metric or number allowing for each tester to have a total or partial ordering relative to all other testers.
   The output from the test scheduler is an ordered list of names of testers who should be scheduled for a test session. The testers are ordered by how much pertinent information each tester will create during the testing.

In some embodiments, the test scheduler goes through the following steps to create the best ordered list of testers:
Retrieve a list of names of all testers and their corresponding data from the database of testers.
Order the list of testers based on their priority scores, and
Schedule the testers in their ranked order to maximize the amount of test data to be captured from the testers starting with the tester who has the highest priority score.

In some embodiments, the test scheduler can be made to predict which media instance(s) will be viewed in the future when a tester arrives, based on the testers who have already scheduled for testing. Such prediction further optimizes the testers who are brought in and creates a more stable testing session by more accurately predicting the overall outcome of testing.

### Priority Score Calculator

In some embodiments, the priority score calculator calculates a ranking, or a priority score value, for each individual media instance and can combine them to create a score for a set of media instances. A priority score of a media instance is high for a tester if the media instance really needs to be tested and if a tester of the media would create a pertinent view for the media instance. On the other hand, the priority score is low for the tester if the media instance does not need to be tested as much, or if the tester does not fit the profile of “correct” testers for the media instance as defined by, for a non-limiting example, the creator of the media instance.

In some embodiments, the priority score of each media instance can take into account at least one or more of the following variables:
Time until the media instance needs to be tested.
Number of times the media instance has already been viewed (tested).
Number of times the media instance still needs to be viewed.
Number of testers who fit in the demographic for testing the media instance.
Distribution of the testers who have already tested the media instance, such as age, gender, location and other metrics.
Priority given to the media instance by an outside ranking.
   These variables are meant to illustrate the metrics and not be a full list as many other metrics can be used as inputs to rank the media instance.

In some embodiments, an overall priority score for the tester can be calculated by combining the scores of individual media instances in the playlist once the playlist has been created. The overall score corresponds to the amount and worth of the information gained by having the selected tester test the set of media in the list. One way to calculate the overall score is to average the individual scores; another way is to add the individual scores together. This overall score can then be used to schedule a testing session based on the priorities of the testers.

In some embodiments, the priority score of a media instance in a testing project can be calculated based on pertinent data about a tester and the media instance to be tested by the tester. Such data includes but is not limited to, due date of the media instance, the number of views already obtained for the media instance, the priority of the media instance, and any other pertinent information. The function to calculate the priorities can be one of the following:
A linear combination of all pertinent heuristics.
A higher ordered mathematical or other combination of the heuristics, which allows for weighting to test certain media instances more often as their due dates get closer.
A function that includes data about the tester and the current demographic distribution of testers who have viewed the media instance. Such data can be used as a filter to refine the media instances for the tester to watch in order to achieve an even demographic distribution of testers for the media instance. Media instances that do not need to be tested by the current tester's demographic will be filtered out of the playlist of media instances of the tester.

In some embodiments, a score can be calculated for each variable that makes up the function. These scores can then be combined either through averaging or other means:

$$Overall score = \frac{Σ scores ( tester , media )}{Number of scores}$$

Here, scores for a variable can be calculated via a non-linear function, making the weighting change drastically depending on the inputs. For a non-limiting example, if there is no need for a 23 year old tester to test a piece of media, the score would be very, very low. More specifically, assuming all scores are in the range between 0 to 1.0, if the media instance has been tested by all 23 year old Georgian natives, and if another one comes along, the score would be low (0.1), whereas if a 35 year old from Idaho comes along, the score would be a 0.9. For another non-limiting example, if there are only two days left to complete testing of a specific media instance, the score could be a 0.8, whereas if there are 20 days left, the score would be a 0.25. These scores can then be combined to create an overall priority score. For the non-limiting examples above, if the media instance had 2 days left to be tested and the tester was from Idaho, the score would be (0.8+0.9)/2=0.85, whereas if another instance of media had 20 days left and was to be watched by a Georgian native, it would have a score of (0.25+0.1)/2=0.175.

### Playlist Creator

In some embodiments, all media instances in the testing project can be ranked based on their resulting priority scores. The ones at the beginning are those most need to be viewed and the ones at the end are those no longer need to be tested anymore. Those ranked at the top can then be added to a playlist for a tester to view. For the non-limiting example discussed above, those two media instances would be ranked accordingly and the first one would have a higher ranking.

In some embodiments, the size of the playlist for a tester is affected by the type of media instances the tester is going to view. For a non-limiting example, a natural size for a playlist of television commercials is roughly 20 of them, approximating the number of ads that viewers currently see in a 30 minute window of television.

In some embodiments, the media instances in the playlist for a tester to watch should be chosen in a way that creates a natural viewing experience for the tester in addition to choosing media instances that fit the tester's demographic to gain the most knowledge from the tester. To keep the experience natural, the playlist should emulate the experience each tester would have at home or wherever the tester normally interacts with the media instances. The goal is to increase testing efficiency of the playlist and reduce bias by up to an order of magnitude or more and, at the same time, effectively pairing testers and media instances so that every time a tester watches a media instance would create a resultant pertinent set of information about that media instance.

In some embodiments, one approach to create a natural experience for a tester is to iteratively take the top ranked media instance and compare it to the filtering rules listed above to determine if it is Ok to include the media instance in the playlist of the tester or not. If the top of the playlist includes media instances from only one industry, company, or other non-ideal subsection of all media instances, the tester will not enjoy a natural experience and may thus create non-ideal testing data. For a non-limiting example, watching 20 beer or laundry detergent ads would not approximate the real world experience for the tester and would create a very strange response from the tester. If a playlist for a tester already has 3 ads from the beer industry, the 4th beer ad would be discarded because there are already too many beer ads for a natural experience for the tester.

In some embodiments, a set of heuristic characteristics or constraints (filtering rules) is created for rating the worth (i.e., amount of pertinent data generated) of each interaction between a tester and a media instance, allowing for a more optimal (natural) overall choice by which testers should be brought in to a testing session and once they are there, which media instances the testers should interact with or watch. For each individual tester, every single media instance can be ranked based on each heuristic. Conversely, media instances can be ranked on a set of dimensions for each tester, creating many different ranked orderings of all media instances.

In some embodiments, the set of heuristics can be based on one or more of:
Information (metadata) about the tester, such as age, gender, income, race, geographic location, buying habits, schooling, jobs, children, and any other pertinent data.
Information (metadata) about the media instances, such as age, gender, location, and other pertinent information of the viewing audience, time until testing completion, how many and what types of testers have already tested the media instance and any other pertinent data.
Information pertaining to the testing project, such as due date, priority, number of media views already existing, demographics of prior viewers, and any other pertinent information.
   The goal is to choose which media instances a tester should watch based on a set of heuristics to maximize the amount of pertinent information gained by each test session.

In some embodiments, the filtering rules for the playlist to make the experience natural for a tester include one or more of following.
The playlist should not include media instances based on a specific set of attributes, which include but are not limited to, producer, industry, campaign, media name, etc.
The playlist should not include too many media instances from the same producer (media production company) or industry, in other words, no more than a predetermined number of media from a single category or producer.
The playlist should not include too many media instances from the same industry.
The playlist should not include the same media instance multiple times in the same session, or multiple times in multiple sessions unless specifically requested. In other words, no media instance that the tester has already seen
The playlist should not include media instances from the same producer or industry in sequential order.
The playlist should include a particular media instance to guarantee that the instance will be seen by the specific tester.
The playlist should include a particular pre-selected media instance at a specific location of the playlist. For non-limiting examples, location at beginning and/or end of the playlist can be excluded, and a specific type of media instance is not before or after another type of instance.
The playlist should not include a particular media instance based on certain restrictions of the media instance and/or information of other testers of the media instance. For non-limiting examples:
   The instance should be viewed by testers from a specific or diversified geographic areas;
   The testers of the instance should include equal number of people from each gender;
   Only 18-34 year old female testers should view the media instance, etc.
The order of the media instances shown in the playlist should be randomized to remove bias from a static playlist.
   Many other pertinent filtering rules can be created and there are many ways to implement these rules to create a natural experience. Using these rules, every single media instance that is tested creates meaningful test data. In addition, because of randomization and the constraints on the media instances, bias of response will be minimized, which greatly increases the correctness of the test data.

### Databases

In some embodiments, the database of testers includes information (metadata) pertaining to each of the testers that allows the testers to be divided into categories. Such information includes, but is not limited to, name, age, gender, race, income, residence, type of job, hobbies, activities, purchasing habits, political views, etc. as described above.

In some embodiments, the database of media stores pertinent data for each media instance, and/or data recorded from viewing of the media instances by the testers, including physiological, survey and other pertinent test data. Once stored, such data can be aggregated and easily accessed for later analysis of the media instances. The pertinent data of each media instance that is being stored includes but is not limited to the following:
The actual media instance for testing, if applicable;
Metadata of the media instance, which can include but is not limited to, production company, brand, product name, category (for non-limiting examples, alcoholic beverages, automobiles, etc), year produced, target demographic (for non-limiting examples, age, gender, income, etc) of the media instances.
Data defining key aspects of the testing project of the media instance, which can include but is not limited to, due date, tester demographics needed, priority of project, industry of media, company name, key competitors and any other pertinent information.
Data recorded for viewing of the media instance by each of the testers, which can include but is not limited to the following and/or other measurement known to people of the art:
   Survey results for surveys asked for each tester before, during and or after the test.
   Physiological data from each tester, including, but not limited to data measured via one or multiple of: EEG, blood oxygen sensors, accelerometers.
   Derived physiological data that correlates with emotional responses by the tester to the environment, which can include but is not limited to feelings of reward, physical engagement, emersion, thought level and others.
Data of the resulting analysis of the media instance, which can include but is not limited to graphs of physiological data, comparisons to other media and other analysis techniques.

### Testing Sessions

In some embodiments, a test administrator is operable to perform one or more of the following: selecting the testers, calculating which testers to schedule for a testing session, checking testers in to create a playlist for each of them, running the testing session, and automatically recording physiological and survey data during the testing session. In addition, the test administrator can order the scheduling of testers based on their priorities. Here, the test administrator can be either an automated program that invites and schedules testers or a human being who calls them and schedules them.

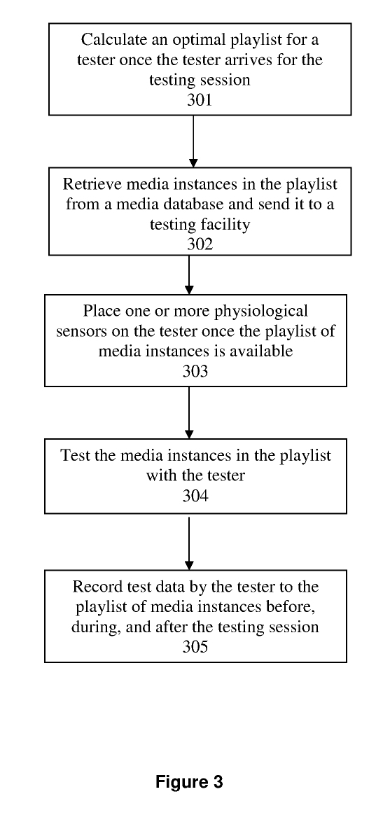

FIG. 3 is a flow chart illustrating an exemplary process to support large scale media testing during a testing session. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

Referring to FIG. 3, an optimal playlist is calculated for a tester once the tester arrives for a testing session at step 301, using up to date data about what has already been tested and what will be tested by other testers. At step 302, the media instances on the playlist are retrieved from the database of media and send it to a testing facility. At step 303, one or more physiological sensors are placed on the tester once the media instances are available. The tester is then tested with the media instances from the optimal playlist at step 304 and test data (responses) by the tester to the media instances on playlist is then recorded before, during, and after the testing session at step 305.

Such novel testing approach records both physiological and survey data, allowing them to be compared and correlated against each other for more accurate and efficient analysis of testing data. The testing data can then be stored into the database of test data and be post-processed to obtain pertinent conclusions about the media instances tested. Note that the testing session does not need to be run by experts, which makes it possible to run testing sessions at any testing facilities distributed around the country. The media instances and the testing data can be transmitted back to a centralized location for storage in the database of test data and/or post processing.

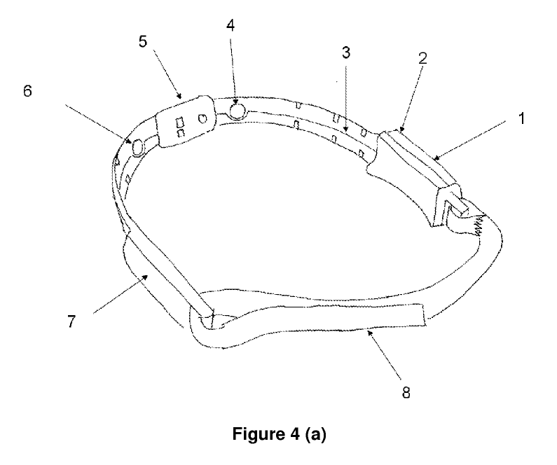

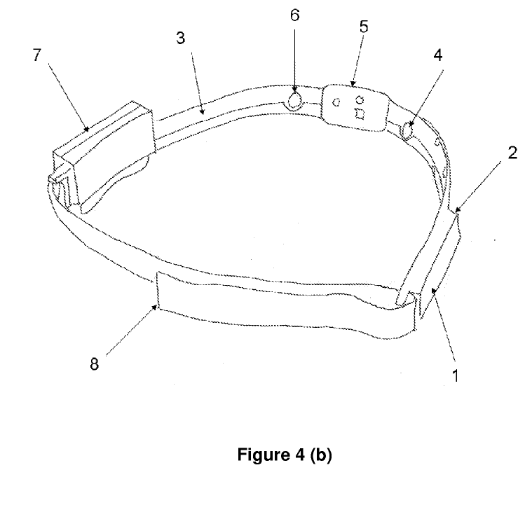

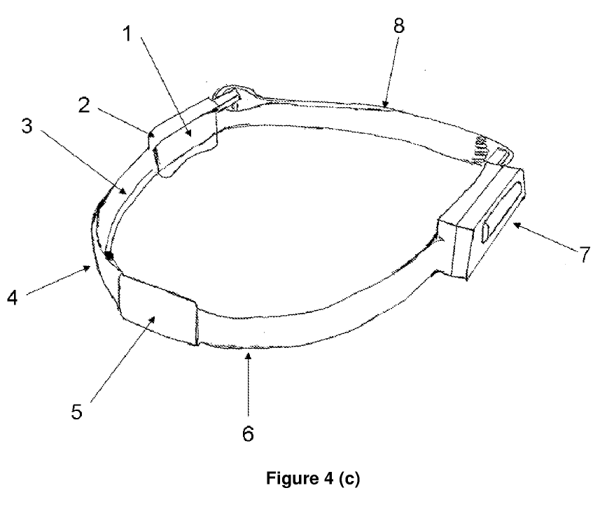

In some embodiments, an integrated headset can be placed on a viewer's head for measurement of his/her physiological data while the viewer is watching an event of the media. The data can be recorded in a program on a computer that allows viewers to interact with media while wearing the headset. FIG. 4 (a)-(c) show an exemplary integrated headset used with one embodiment of the present invention from different angles. Processing unit 401 is a microprocessor that digitizes physiological data and then processes the data into physiological responses that include but are not limited to thought, engagement, immersion, physical engagement, valence, vigor and others. A three axis accelerometer 402 senses movement of the head. A silicon stabilization strip 403 allows for more robust sensing through stabilization of the headset that minimizes movement. The right EEG electrode 404 and left EEG electrode 406 are prefrontal dry electrodes that do not need preparation to be used. Contact is needed between the electrodes and skin but without excessive pressure. The heart rate sensor 405 is a robust blood volume pulse sensor positioned about the center of the forehead and a rechargeable or replaceable battery module 407 is located over one of the ears. The adjustable strap 408 in the rear is used to adjust the headset to a comfortable tension setting for many different head sizes.

In some embodiments, the integrated headset can be turned on with a push button and the viewer's physiological data is measured and recorded instantly. The data transmission can be handled wirelessly through a computer interface that the headset links to. No skin preparation or gels are needed on the viewer to obtain an accurate measurement, and the headset can be removed from the viewer easily and can be instantly used by another viewer, allows measurement to be done on many participants in a short amount of time and at low cost. No degradation of the headset occurs during use and the headset can be reused thousands of times.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more computing devices to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human viewer or other mechanism utilizing the results of the present invention. Such software may include, but is not limited to, device drivers, operating systems, execution environments/containers, and applications.

The foregoing description of the preferred embodiments of the present invention has been provided for the purposes of illustration and description. It is not intended to be exhaustive or to limit the invention to the precise forms disclosed. Many modifications and variations will be apparent to the practitioner skilled in the art. Particularly, while the concepts of “calculator”, “creator”, and “scheduler” are used in the embodiments of the systems and methods described above, it will be evident that such concepts can be interchangeably used with equivalent concepts such as, class, method, type, interface, (software) module, bean, component, object model, and other suitable concepts. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

What is claimed is:

1. A system to support large scale media testing by human testers, comprising:
a test scheduler operable to choose and schedule a plurality of testers for a plurality of media instances in a testing project;
a priority score calculator operable to calculate a priority score for each of the plurality of media instances as being viewed by one of the plurality of testers;
a playlist creator operable to create for a specific tester a playlist of media instances that have the highest priority scores for the specific tester to watch during a testing session;
a tester database operable to store metadata pertinent to each of the plurality of testers; and
a media database operable to store metadata pertinent to each of the plurality of media instances and/or test data recorded from viewing of the plurality of media instances by the plurality of testers.

2. The system of claim 1, wherein:
each of the plurality of media instances is a TV commercial, a printed media, or a web site.

3. The system of claim 1, wherein:
the test scheduler is operable to:
retrieve pertinent data of the plurality of testers from the tester database;
order the plurality of testers based on their priority scores; and
schedule the plurality of testers in their ranked order to maximize the amount of test data to be captured from the testers.

4. The system of claim 1, wherein:
the test scheduler is operable to choose the plurality of testers based on the amount of pertinent test data the plurality of testers can generate for the plurality of media instances.

5. The system of claim 4, wherein:
the pertinent data is a set of metrics needed to make conclusions about the plurality of media instances and/or their priorities to be tested.

6. The system of claim 1, wherein:
the test scheduler is operable to predict which of the plurality of media instances should be viewed in the future by one of the plurality of testers.

7. The system of claim 1, wherein:
the priority score calculator is further operable to calculate an overall priority of the media instances on the playlist of the tester.

8. The system of claim 1, wherein:
the priority score calculator is further operable to calculate the priority score of the media instance to be tested based on pertinent data about the tester and the media instance.

9. The system of claim 1, wherein:
the playlist creator is further operable to choose the media instances in the playlist in such a way that creates a natural viewing experience for the tester.

10. The system of claim 1, wherein:
the playlist creator is further operable to choose the media instances in the playlist based on a set of heuristics and/or filtering rules.

11. The system of claim 1, wherein:
the metadata pertinent to each of the plurality of testers includes one or more of: age, gender, income, race, geographic location, buying habits, schooling, job, children, and any other pertinent data of the tester.

12. The system of claim 1, wherein:
the metadata pertinent to each of the plurality of media instances includes one or more of: production company, brand, product name, category, year produced, and target demographic of the media instance.

13. The system of claim 1, further comprising:
a test administrator operable to perform one or more of:
selecting the plurality of testers;
checking the plurality of testers in and creating a playlist for them,
calculating which of the plurality of testers to schedule during the testing session;
running the testing session; and
recording automatically physiological and/or survey data from the plurality of testers during the testing session.

14. A method to support large scale media testing by human testers, comprising:
maintaining pertinent information of a plurality of testers and/or a plurality of media instances to be tested by the testers;
selecting a set of the plurality of testers to test a pertinent set of the plurality of media instances during a single testing session based on the information on the plurality of testers and the plurality of media instances;
creating a customized playlist of media instances for each of the plurality of testers to watch and/or interact with during the testing session to maximize the pertinent test data provided from each of the plurality of testers;
recording pertinent test data before, during, and after the tester interacts with the media instances in the playlist; and
aggregating and storing the test data automatically for viewing and/or processing.

15. A method to support large scale media testing during a testing session, comprising:
calculating an optimal playlist for a tester once the tester arrives for the testing session;
retrieving media instances in the playlist from a media database and send it to a testing facility;
placing one or more physiological sensors on the tester once the playlist of media instances is available;
testing the media instances in the playlist with the tester; and
recording test data by the tester to the playlist of media instances before, during, and after the testing session.

16. The method of claim 15, wherein:
the one or more physiological sensors can be an integrated headset.

17. The method of claim 15, further comprising:
recording both physiological and survey data of the tester; and
comparing and correlating the physiological and survey data against each other.

18. The method of claim 15, further comprising:
transmitting, storing, and processing the test data at a centralized location different from the location of the testing facility.

19. A machine readable medium having instructions stored thereon that when executed cause a system to:
maintain pertinent information of a plurality of testers and/or a plurality of media instances to be tested by the testers;
select a set of the plurality of testers to test a pertinent set of the plurality of media instances during a single testing session based on the information on the plurality of testers and the plurality of media instances;
create a customized playlist of media instances for each of the plurality of testers to watch and/or interact with during the testing session to maximize the pertinent test data provided from each of the plurality of testers;
record pertinent test data before, during, and after the tester interacts with the media instances in the playlist; and
aggregate and store the test data automatically for viewing and/or processing.

20. A system to support large scale media testing during a testing session, comprising:
means for calculating an optimal playlist for a tester once the tester arrives for the testing session;
means for retrieving media instances in the playlist from a media database and send it to a testing facility;
means for placing one or more physiological sensors on the tester once the playlist of media instances is available;
means for testing the media instances in the playlist with the tester; and
means for recording test data by the tester to the playlist of media instances before, during, and after the testing session.
